(19) United States
(12) Patent Application Publication
(10) Pub. No.: US 2004/0227369 A1
(43) Pub. Date: Nov. 18, 2004

(54) Lifting mechanism for raising and lowering truck box caps

(76) Inventors: Robert W. B. Davidson, Kanata (CA); Douglas William Gibson, (US)

Correspondence Address: James A. Sheridan, Pandiscio & Pandiscio, P.C., 470 Totten Pond Road, Waltham, MA, 02451-1914, US

(21) Appl. No.: 10/700,145

(22) Filed: Nov. 3, 2003

Related U.S. Application Data
(60) Provisional application No. 60/423,059, filed on Nov. 1, 2002.

(51) Int. Cl. B60P 3/34

(52) U.S. Cl. 296/26.07

(57) ABSTRACT

The present invention discloses a lifting mechanism to raise and lower a truck cap relative to a truck box, the mechanism comprising a pair of lifting devices, which comprise a support member for engagement with the truck cap, a base attached to the truck box, at least one first and at least one second guide attached to the base, each of the guides having at least one block slidably engaged therewith, each of the blocks being connected to a link extending to the support member and means for moving the blocks along the guides, the blocks on the second guide being adapted to move in an opposite direction to the blocks on the first guide, whereby movement of the blocks result in scissor-like movement of the links.

### CROSS-REFERENCE TO RELATED APPLICATIONS

The present application claims the benefits of U.S. provisional patent application No. 60/423,059 filed Nov. 1, 2002, which is hereby incorporated by reference.

### TECHNICAL FIELD

The present invention relates to a lifting mechanism for raising and lowering a truck cap relative to a truck box.

### BACKGROUND

Lifting mechanisms for covers and caps of truck beds, also called truck boxes, are well known. Their primary use is to provide more vertical space. The benefits of the additional vertical space are numerous. People may stand up while moving inside the truck box instead of remaining bent over. Taller items may be loaded into the truck box. Items that would fit into the truck box with the cap lowered but are difficult to load into a confined space may be more easily loaded into the truck box with the cap raised. Some examples of prior art are U.S. Pat. Nos. 4,603,901, 4,981,319, 5,364,154, 5,366,266, 5,375,900, 6,086,134, and 6,209,944.

The liftable tops listed above have most or all of the following drawbacks. Some have a special cover included as part of the lifting mechanism. For users who already own a truck cap, or who want to purchase a certain type of truck cap, having the lifting mechanism already attached to a cover is not commercially acceptable. Some require modifications to either the truck cap, truck box, or both. Modifications to the truck box are highly undesirable while modifications to the cap should be minimal. Others are restricted in the height to which the truck caps may be lifted. Yet others do not include means for automatically lifting the truck cap.

Accordingly, it is an object of the present application to obviate or mitigate the above disadvantages.

### SUMMARY

In one aspect of the present invention, there is provided a lifting mechanism A lifting mechanism to raise and lower a truck cap relative to a truck box, said mechanism comprising a pair of lifting devices, said devices comprising:

a support member for engagement with said truck cap;

a base attached to said truck box;

at least one first and at least one second guide attached to said base;

each of said at least first and at least second guides having at least one block slidably engaged therewith;

each of said blocks being connected to a link extending to the support member; and

means for moving said blocks along said guides, the blocks on said at least one second guide being adapted to move in an opposite direction to said blocks on said at least one first guide; whereby movement of the blocks result in scissor-like movement of the links.

In another aspect of the present invention, there is further provided a lifting mechanism to raise and lower a truck cap relative to a truck box, said mechanism comprising a pair of lifting devices, said devices comprising:

a support member for engagement with said truck cap;

a base attached to said truck box;

a first and a second threaded rods attached to said base;

said first and said second threaded rods having at a pair of threaded blocks slidably engaged therewith;

each of said threaded blocks being connected to a link extending to the support member; and

means for moving said threaded blocks along said guides, the threaded blocks on said second threaded rod being adapted to move in an opposite direction to said threaded blocks on said first threaded rod;

whereby movement of the threaded blocks result in scissor-like movement of the links.

### BRIEF DESCRIPTION OF THE FIGURES

Embodiments of the invention will be described by way of example only with the help of the accompanying figures.

FIG. 1 is a side view of a pickup truck with a cap mounted on the truck box.

FIG. 2 is a side view of a pickup truck with a cap raised relative to the truck box using.

FIG. 3 is a perspective view of a lifting system.

FIG. 4A is a cross-sectonal view (along axis IV-IV as shown in FIG. 3) of the lifting device in the lowered position.

FIG. 4B is a cross-sectional view (along axis IV-IV as shown in FIG. 3) of the lifting device in the raised position.

FIG. 5 is a cross-sectional view (along axis V-V as shown in FIG. 3) of the lifting device base.

FIG. 6 is a cross-sectional view (along axis VI-VI as shown in FIG. 3) of the lifting device base.

FIG. 7 is a cross-sectional view (along axis VII-VII as shown in FIG. 3) of the lifting device base.

FIG. 8 is a perspective view of the lifting device base with means for manually operating the lifting device.

FIG. 9 is an exploded perspective view of the inside of a truck cap and truck bed.

FIG. 10A is an exploded perspective view of the inside of a truck cap and truck bed showing mounting brackets.

FIG. 10B is an exploded perspective view of an alternative embodiment of FIG. 10A.

FIG. 11 is a perspective view of the inside of a truck cap and truck bed showing a lifting device.

FIG. 12 is a detail view of the securing of the lifting device to the truck cap.

### DETAILED DESCRIPTION

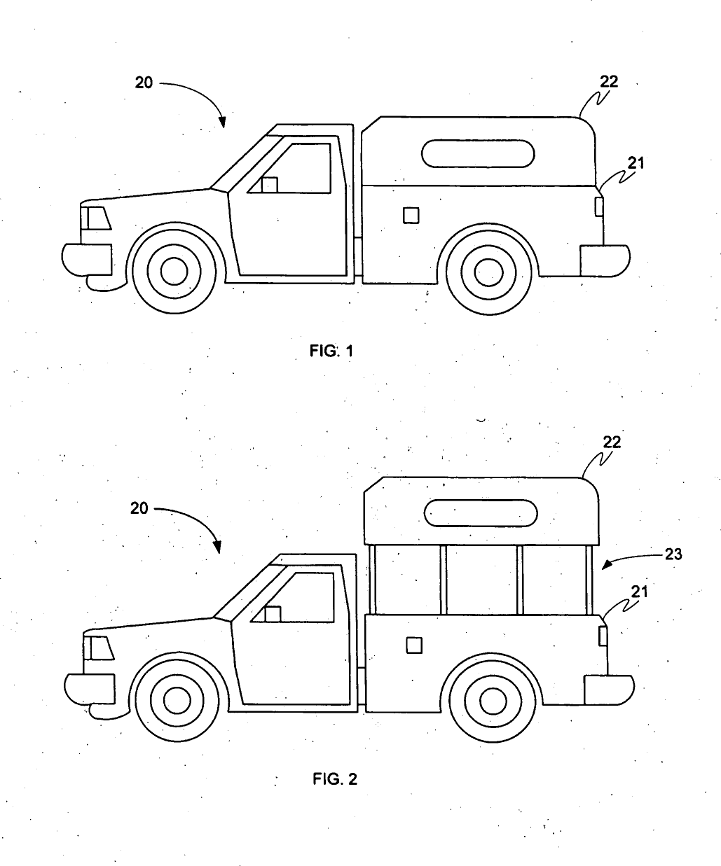

FIG. 1 shows a pickup truck 20 comprising a box 21, which is covered by a cap 22. Using lifting mechanism 23 (partially hidden), cap 22 may be raised relative to box 21, as shown in FIG. 2.

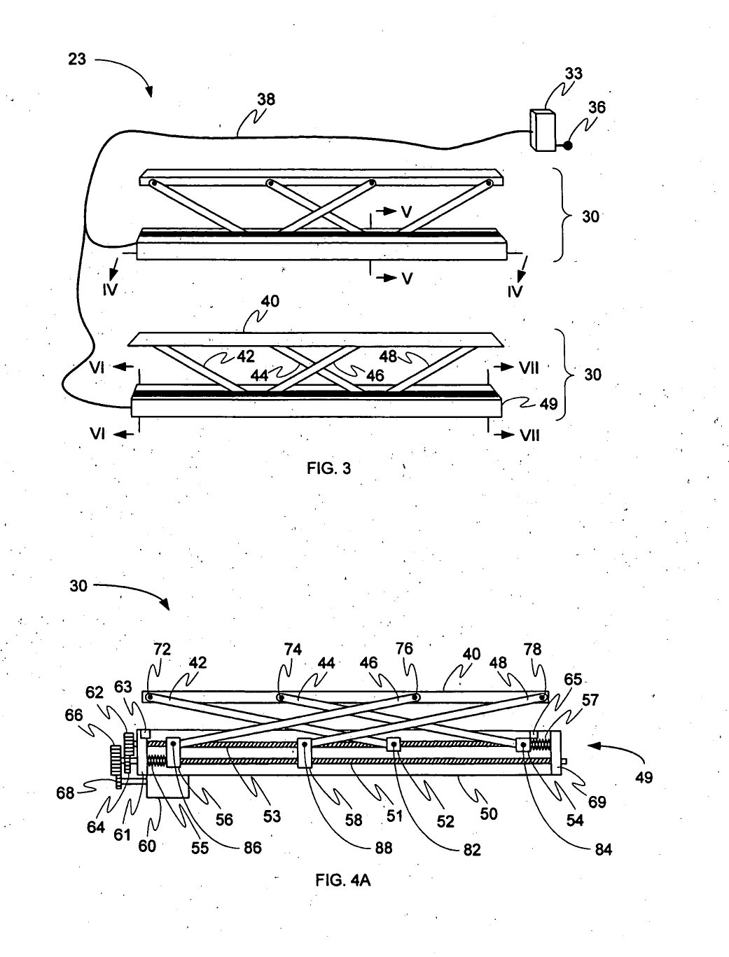

Referring to FIG. 3, the lifting mechanism 23 comprises a pair of lifting devices 30, which are to be preferably placed longitudinally within the truck box 21 along its inside lateral walls. Each lifting device 30 comprises a support member 40, to be secured to its respective side of truck cap 22, which is connected to base 49 via links 42, 44, 46, and 48. Base 49 is attached to either the inside walls or the floor of truck box 21. In one embodiment, the lifting mechanism 23 further comprises a switching circuit 33 for controlling the motion of the lifting devices 30. Switching circuit 33 includes a switch 36, for example a toggle switch, a lever or a button, which may be used to control the direction of movement of lifting devices 30, i.e. to raise or lower truck cap 22. The switching circuit may also include a lock to stop unauthorized use of the lifting mechanism 23. Wiring 38 interconnects switching circuit 33 with lifting devices 30.

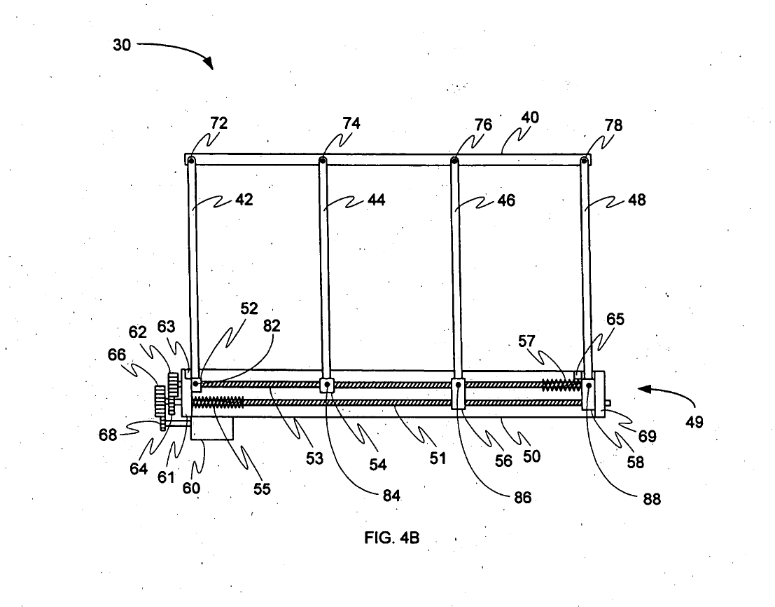

Lifting device 30 is shown in more details in a lowered position in FIG. 4A and in a raised position in FIG. 4B. Base 49 comprises a housing 50, preferably a box like structure, which includes a pair of guides, in the form of generally parallel threaded rods 51 and 53, extending along its length, motor 60, gears 62, 64, 66 and 68 and threaded blocks 52, 54, 56 and 58. Although a pair of guides are shown, more than two guides may be used as well. FIGS. 4A and 4B also show optional biasing members, such as springs 55 and 57 and safety stop switches 63 and 65 which will be described further below.

Threaded rods 51 and 53 are positioned one above the other in an over-under configuration in order to reduce the overall width of base 49 and are held in position by the base 49 end plates 61 and 69. Threaded blocks 52 and 54 are threaded onto upper threaded rod 53 while threaded blocks 56 and 58 are threaded onto lower threaded rod 51. Alternate arrangements such as side-by-side may also be possible.

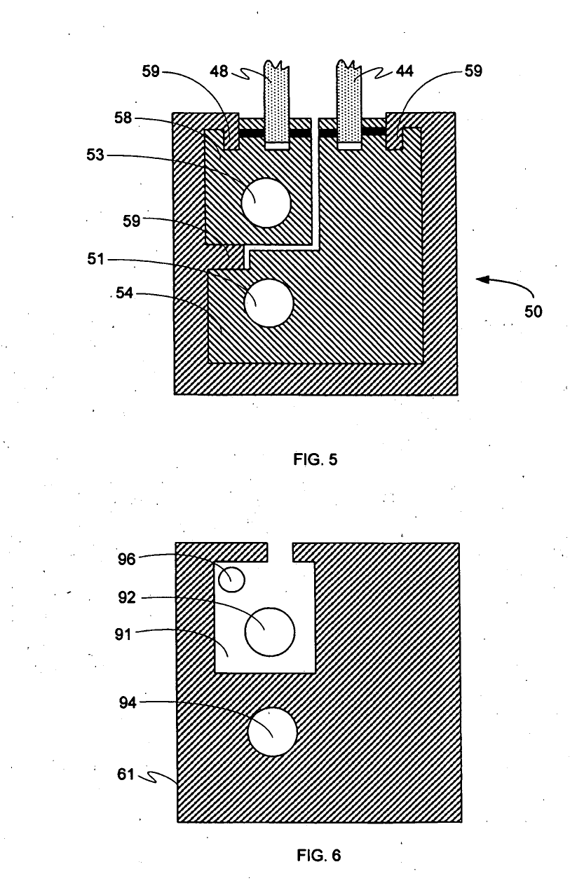

In the over-under configuration the threaded blocks 52, 54, 56 and 58 must be designed such that threaded blocks 52 and 54 positioned on upper threaded rod 53 do not interfere with threaded blocks 56 and 58 positioned on lower threaded rod 51 as they pass by each other while moving in opposite directions during the raising or lowering of support member 40. FIG. 5 shows a cross-sectional view of housing 50, illustrating how threaded blocks 54 and 58 are configured such that the do not do not interfere with each other. Threaded blocks 52 and 54 are generally square shaped while threaded blocks 56 and 58 are generally L shaped, allowing threaded blocks 52 and 54 to pass by threaded blocks 56 and 58 unhindered. Preferably, housing 50 also includes ledges 59, which provide support and guide threaded blocks 52, 54, 56 and 58 along threaded rods 51 and 53.

As mentioned previously, links 42, 44, 46, and 48 extend between and interconnect base 49 with support member 40. To this end, links 42, 44, 46, and 48 are pivotally connected to support member 40 with pins 72, 74, 76 and 78 and to threaded blocks 52, 54, 56 and 58 with pins 82, 84, 86 and 88 respectively.

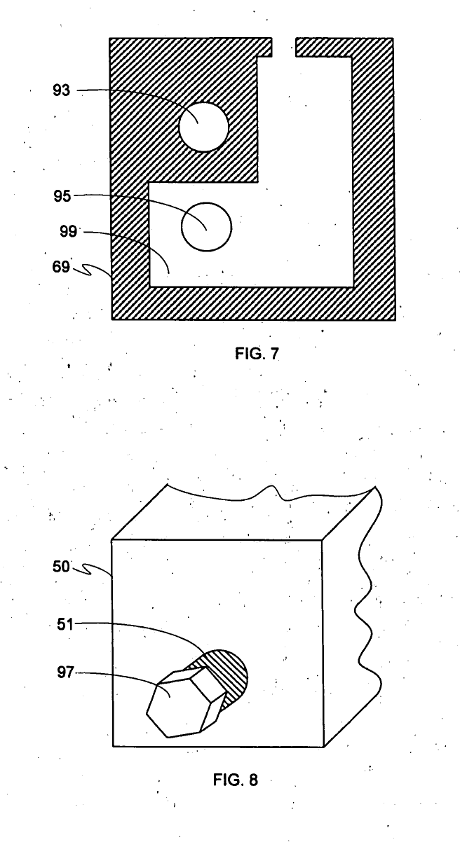

Additional support may be provided to lifting device 30 when it is in its fully raised position as shown in FIG. 4B. The additional support is achieved when threaded blocks 52 and 58, and associated links 42 and 48, partially enter into recessed areas 91 and 99 of end plates 61 and 69, shown in FIGS. 6 and 7. End plates 61 and 69 further comprise holes 92 and 93 for holding threaded rod 53 and holes 94 and 95 for holding threaded rod 51. Also shown in FIG. 6 is mounting hole 96 for switch 63.

Gears 62, 64, 66 and 68 provide means for motor 60 to rotate threaded rods 51 and 53 at the same rate and in opposite directions. For example, if motor 60 is rotating clockwise, attached gear 68 will also rotate clockwise and it will cooperate with gear 66, which will rotate counter-clockwise. Gear 64 and threaded rod 51 attached to gear 66 will thus also rotate counter-clockwise. Gear 64, rotating counter-clockwise, cooperates with gear 62, which will rotate clockwise, and so will threaded rod 53, which is attached to gear 62. Since threaded rods 51 and 53 have the same thread orientation, threaded blocks 52 and 54 will move in one direction while threaded blocks 56 and 58 will move in the opposite direction, which will cause links 42, 46 and 44, 48 to move in a scissor-like fashion, raising or lowering support 40, which is secured to truck cap 22. With the motor 60 rotating in one direction, the support member 40 may be raised while remaining generally parallel to base 49. Reversing the direction of motor 60 will lower the support member 40 in a like manner. Of course, reversing the thread orientation of one of the threaded rods 51 or 53 may while also changing the gear arrangement so that the threaded rods 51 and 53 rotate in the same direction will achieve the same results.

Well known methods exist for selecting gears and threaded rods. An appropriate selection of gear and thread specifications permits the use of a compact and low power motor 60 to lift loads in excess of several hundred pounds. One example is to use a 1 hp motor 60, 6 threads per inch threaded rods 51 and 53, 42 tooth gears 62 and 64, 84 tooth gear 66 and 22 tooth gear 68. Persons skilled in the art may easily find other configurations that meet their specific requirements.

As mentioned previously, springs 55 and 57 may be used to assist motor 60 in raising support member 40. Referring to FIG. 4A, lifting device 30 is shown in the lowered position. In this position the energy required to move the threaded blocks 52, 54, 56 and 58 for the first several inches may be significantly greater than when the lifting device 30 is approaching the fully raised position, as shown in FIG. 4B. This is due to the fact that in the lowered position, links 42, 44, 46, and 48 are almost parallel to the path of threaded blocks 52, 54, 56 and 58. To assist in moving the threaded blocks 52, 54, 56 and 58, springs 55 and 57 are placed around threaded rods 51 and 53 as shown in FIGS. 4A and 4B. In the lowered position, springs 55 and 57 are compressed, while in the raised position, springs 55 and 57 are expanded.

Safety stop switches 63 and 65 may also be used to automatically shut off motor 60 when the lifting device 30 reaches the fully raised or fully lowered positions. Switch 65, in conjunction with switching circuit 33, will stop motor 60 when threaded block 54 makes contact with switch 65 just as threaded block 54 reaches a position such that the lifting device 30 is fully lowered. Similarly, switch 63, in conjunction with switching circuit 33, will stop the motor 60 when threaded block 52 makes contact with switch 63 just as threaded block 52 reaches a position such that the lifting device 30 is fully raised.

As will be understood by persons skilled in the art, the rotation of threaded rod 51 may be achieved manually as well as with the help of a motor 60. FIG. 8 shows base 49 with threaded rod 51 protruding from the end plate 69. In one embodiment, a nut 97 is provided at the end of threaded rod 51 so that it may be rotated manually with the help of a tool. For example, nut 97 may be a standard sized hexagonal automotive wheel lug nut, which may be rotated using a standard tire iron, which is generally issued with all vehicles, including pickup trucks, thereby raising or lowering the support member 40.

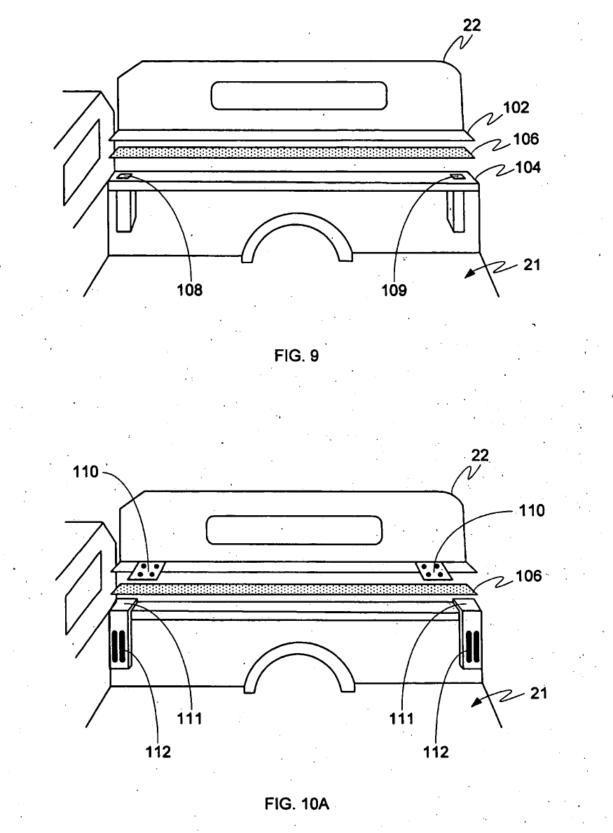

FIG. 9 shows an exploded view of the inside of a truck bed 21 and truck cap 22 combination. Generally, truck cap 22 has a cap rail 102, which serves as a base for truck cap 22, that rests on truck box rail 104. Generally as well, a gasket 106 is fixed to the bottom of the cap rail 102 providing a non-abrasive cushion as well as a weatherproof seal between the cap rail 102 and the box rail 104. Truck box postholes 108 and 109 are generally used for mounting side walls on a truck bed 21.

In FIG. 10A, cap rail 102 mounting brackets 110 and posthole mounting brackets 111 are shown. Cap rail 102 mounting brackets 110 may be secured to the cap rail 102 using, for example, standard nuts and bolts, or screws. With a gasket 106 in place, the screw or bolt heads will not touch the box rail 104 surface. Posthole mounting brackets 111 simply drop into the truck box postholes 108 and 109 and hang on the inside of the truck box 21. Slots 112 are used to fasten the brackets to base 49 while allowing for vertical adjustment of the lifting device 30 during installation. In an alternate embodiment, the mounting brackets 111 may be secured, as shown in FIG. 10B, to the side of box rail 104 and the interior wall of truck bed 21 using, for example, standard nuts and bolts, or screws 113.

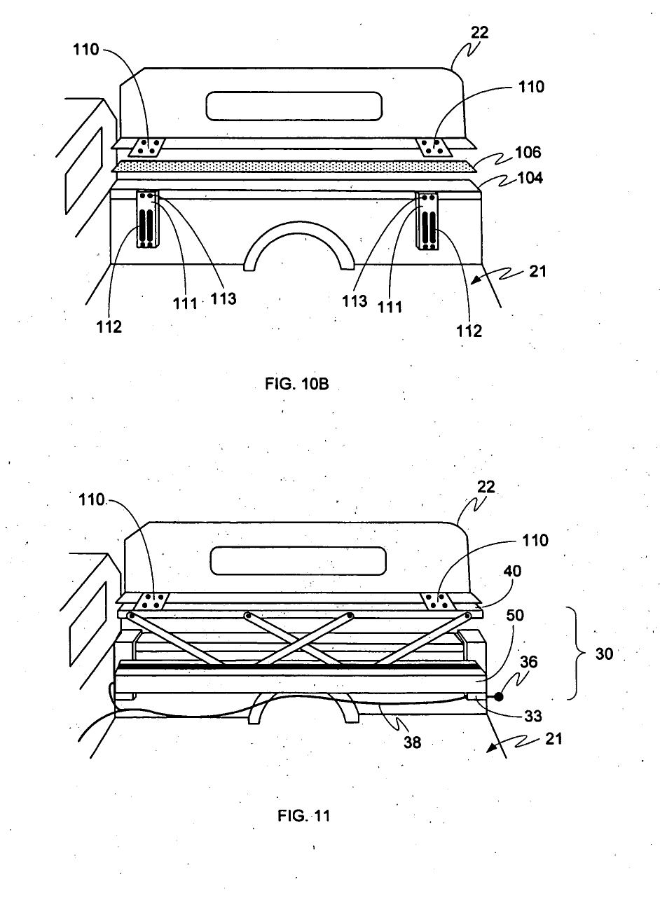

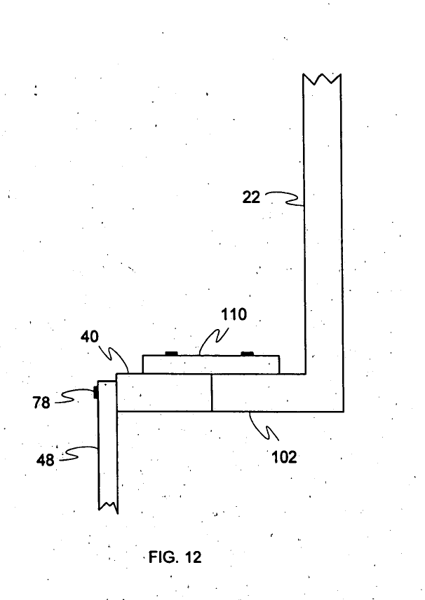

FIG. 11 shows the installation of lifting device 30. Support member 40 is secured to cap rail 102 mounting brackets 110 while base 49 is secured to posthole mounting brackets 111 and adjusted using slots 112. FIG. 12 shows in more detail the cap rail 102 mounting bracket 110 secured to both the cap rail 102 and support member 40, thus engaging the lifting device 30 to the truck cap 22. Switching circuit 33 may be secured to base 49. The other lifting device 30 (not shown) is installed in a similar fashion but on the other side of the truck bed 21. In another embodiment, base 49 may be secured directly to the floor or the inside walls of the truck box 21.

Alternative embodiments of the invention may use a different number of blocks with associated links. The guides, which is are threaded rods in the described embodiments, may be replaced with a belt entrained about a pair of wheels or with hydraulic cylinders. Pulleys may also be used instead of gears to drive the threaded rods. The blocks may be combined into a single block having two or more spaced apart connection points to which the links are connected. As well, the springs may be replaced by other types of biasing members or may be omitted altogether.

Although the present invention has been described by way of particular embodiments thereof, it should be noted that it will be apparent to persons skilled in the art that modifications may be applied to the present particular embodiment without departing from the scope of the present invention.

What is claimed is:

1. A lifting mechanism to raise and lower a truck cap relative to a truck box, said mechanism comprising a pair of lifting devices, said devices comprising:
a) a support member for engagement with said truck cap;
b) a base attached to said truck box;
c) at least one first and at least one second guide attached to said base;
d) each of said at least first and at least second guides having at least one block slidably engaged therewith;
e) each of said blocks being connected to a link extending to the support member; and
f) means for moving said blocks along said guides, the blocks on said at least one second guide being adapted to move in an opposite direction to said blocks on said at least one first guide;
whereby movement of the blocks result in scissor-like movement of the links.

2. A lifting mechanism according to claim 1, wherein said at least first and at least second guides are threaded rods.

3. A lifting mechanism according to claim 2, wherein at least one of said threaded rods is connected to an electric motor.

4. A lifting mechanism according to claim 2, wherein a partial length of at least one of said threaded rods is enclosed by a biasing member.

5. A lifting mechanism according to claim 4, wherein said biasing member is a spring.

6. A lifting mechanism according to claim 1, wherein said at least first and at least second guides are hydraulic cylinders.

7. A lifting mechanism according to claim 1, wherein said at least first and at least second guides are the upper and lower runs of a belt which is entrained about a pair of wheels in an endless loop.

8. A lifting mechanism according to claim 7, wherein at least one of said wheels is being operated by an electric motor.

9. A lifting mechanism according to claims 1, wherein said base further comprises at least one recess for supporting at least one of said blocks.

10. A lifting mechanism according to claim 1, wherein said base is secured directly to the sides of said truck box.

11. A lifting mechanism according to claim 1, wherein said base is secured directly to the floor of said truck box.

12. A lifting mechanism according to claim 1, wherein said base is secured to at least one posthole mounting bracket.

13. A lifting mechanism according to claim 1, further comprising a switching circuit for controlling the motion of said lifting mechanism.

14. A lifting mechanism according to claim 1, further comprising a lock to stop unauthorized use of said lifting mechanism.

15. A lifting mechanism according to claim 1, further comprising a safety switch for stopping the motion of said lifting mechanism when it reaches a fully raised position.

16. A lifting mechanism according to claim 1, further comprising a safety switch for stopping the motion of said lifting mechanism when it reaches a fully lowered position.

17. A lifting mechanism to raise and lower a truck cap relative to a truck box, said mechanism comprising a pair of lifting devices, said devices comprising:
a) a support member for engagement with said truck cap;
b) a base attached to said truck box;
c) a first and a second threaded rods attached to said base;
d) said first and said second threaded rods having at a pair of threaded blocks slidably engaged therewith;
e) each of said blocks being connected to a link extending to the support member; and
f) means for moving said threaded blocks along said guides, the threaded blocks on said second threaded rod being adapted to move in an opposite direction to said threaded blocks on said first threaded rod;
whereby movement of the threaded blocks result in scissor-like movement of the links.

18. A lifting mechanism according to claim 17, wherein at least one of said threaded rods is connected to an electric motor.

19. A lifting mechanism according to claim 17, wherein a partial length of at least one of said threaded rods is enclosed by a biasing member.

20. A lifting mechanism according to claim 19, wherein said biasing member is a spring.

21. A lifting mechanism according to claims 17, wherein said base further comprises at least one recess for supporting at least one of said threaded blocks.

22. A lifting mechanism according to claim 17, wherein said base is secured directly to the sides of said truck box.

23. A lifting mechanism according to claim 17, wherein said base is secured directly to the floor of said truck box.

24. A lifting mechanism according to claim 17, wherein said base is secured to at least one posthole mounting bracket.

25. A lifting mechanism according to claim 17, further comprising a switching circuit for controlling the motion of said lifting mechanism.

26. A lifting mechanism according to claim 17, further comprising a lock to stop unauthorized use of said lifting mechanism.

27. A lifting mechanism according to claim 17, further comprising a safety switch for stopping the motion of said lifting mechanism when it reaches a fully raised position.

28. A lifting mechanism according to claim 17, further comprising a safety switch for stopping the motion of said lifting mechanism when it reaches a fully lowered position.
